(19) United States
(12) Patent Application Publication
(10) Pub. No.: US 2024/0256157 A1
(43) Pub. Date: Aug. 1, 2024

(54) Adaptive Cache Management System and Method

(71) Applicant: Dell Products L.P., Round Rock, TX (US)

(72) Inventors: Vladimir Shveidel, Pardes-Hana (IL); Lior Kamran, Rishon LeZion (IL); Amitai Alkalay, Kadima (IL)

(21) Appl. No.: 18/159,723

(22) Filed: Jan. 26, 2023

(51) Int. Cl. G06F 3/06

(52) U.S. Cl. CPC G06F 3/0631; G06F 3/0614; G06F 3/0653; G06F 3/0679

(57) ABSTRACT

A method, computer program product, and computing system for identifying a cache probe event associated with a cache memory system. A cache size of the cache memory system may be adjusted based upon, at least in part, the cache probe event. A cache size adjustment impact may be determined based upon, at least in part, a change in a hit rate associated with the cache memory system. It may be determined whether to further adjust the cache size of the cache memory system based upon, at least in part, the cache size adjustment impact.

### BACKGROUND

Storing and safeguarding electronic content may be beneficial in modern business and elsewhere. Accordingly, various methodologies may be employed to protect and distribute such electronic content.

For example, consider a storage system that implements a cache for fast data access. The system may use multiple cache instances, each of them may store one or more types of pages. Normally, a “hit ratio” metric is used to analyze how the cache is performing, by calculating the number of cache hits (i.e., the requested page was found in cache) divided by the total number of requests. However, this metric is very general, and may fail to detect cache inefficiencies. For example, consider a scenario where all the requests to the cache are for only e.g., five pages, out of 20,000 pages stored in the cache. In this case, the hit ratio will be equal to “1”, hiding the memory inefficiency, because significant memory portion may be freed up from the cache to be used by other cache instances or different system components, while getting the same cache performance and hit ratio of “1”.

Thus, such simple metrics do not represent whether the cache size is optimal or, for example, whether the cache size may be decreased by half, without visible performance impact; or the opposite—whether increasing the cache size by just e.g., five percent may improve the hit rate, and the performance dramatically.

### Summary of Disclosure

In one example implementation, a computer-implemented method executed on a computing device may include, but is not limited to, identifying a cache probe event associated with a cache memory system. A cache size of the cache memory system may be adjusted based upon, at least in part, the cache probe event. A cache size adjustment impact may be determined based upon, at least in part, a change in a hit rate associated with the cache memory system. It may be determined whether to further adjust the cache size of the cache memory system based upon, at least in part, the cache size adjustment impact.

One or more of the following example features may be included. The cache memory system may include one or more of: a metadata cache and a user data cache. The cache probe event may include one or more of: a change in IO pattern, a change in cache memory system metrics, and a periodic cycle. Adjusting the cache size of the cache memory system may include one or more of: adding a portion of storage capacity to the cache memory system, and removing a portion of storage capacity from the cache memory system. Determining the cache size adjustment impact may include comparing a hit rate associated with the cache memory system prior to adjusting the cache size to a hit rate associated with the cache memory system after adjusting the cache size. Determining whether to further adjust the cache size of the cache memory system may include: determining that the hit rate associated with the cache memory has decreased in response to removing a portion of storage capacity from the cache memory system; and adjusting the cache size by adding the portion of storage capacity previously removed from the cache memory system. Determining whether to further adjust the cache size of the cache memory system may include: determining that the hit rate associated with the cache memory has not changed in response to adding a portion of storage capacity to the cache memory system; and adjusting the cache size by removing the portion of storage capacity previously added to the cache memory system.

In another example implementation, a computer program product resides on a computer readable medium that has a plurality of instructions stored on it. When executed by a processor, the instructions cause the processor to perform operations that may include, but are not limited to, identifying a cache probe event associated with a cache memory system. A cache size of the cache memory system may be adjusted based upon, at least in part, the cache probe event. A cache size adjustment impact may be determined based upon, at least in part, a change in a hit rate associated with the cache memory system. It may be determined whether to further adjust the cache size of the cache memory system based upon, at least in part, the cache size adjustment impact.

One or more of the following example features may be included. The cache memory system may include one or more of: a metadata cache and a user data cache. The cache probe event may include one or more of: a change in IO pattern, a change in cache memory system metrics, and a periodic cycle. Adjusting the cache size of the cache memory system may include one or more of: adding a portion of storage capacity to the cache memory system, and removing a portion of storage capacity from the cache memory system. Determining the cache size adjustment impact may include comparing a hit rate associated with the cache memory system prior to adjusting the cache size to a hit rate associated with the cache memory system after adjusting the cache size. Determining whether to further adjust the cache size of the cache memory system may include: determining that the hit rate associated with the cache memory has decreased in response to removing a portion of storage capacity from the cache memory system; and adjusting the cache size by adding the portion of storage capacity previously removed from the cache memory system. Determining whether to further adjust the cache size of the cache memory system may include: determining that the hit rate associated with the cache memory has not changed in response to adding a portion of storage capacity to the cache memory system; and adjusting the cache size by removing the portion of storage capacity previously added to the cache memory system.

In another example implementation, a computing system includes at least one processor and at least one memory architecture coupled with the at least one processor, wherein the at least one processor is configured to identify a cache probe event associated with a cache memory system. A cache size of the cache memory system may be adjusted based upon, at least in part, the cache probe event. A cache size adjustment impact may be determined based upon, at least in part, a change in a hit rate associated with the cache memory system. It may be determined whether to further adjust the cache size of the cache memory system based upon, at least in part, the cache size adjustment impact.

One or more of the following example features may be included. The cache memory system may include one or more of: a metadata cache and a user data cache. The cache probe event may include one or more of: a change in IO pattern, a change in cache memory system metrics, and a periodic cycle. Adjusting the cache size of the cache memory system may include one or more of: adding a portion of storage capacity to the cache memory system, and removing a portion of storage capacity from the cache memory system. Determining the cache size adjustment impact may include comparing a hit rate associated with the cache memory system prior to adjusting the cache size to a hit rate associated with the cache memory system after adjusting the cache size. Determining whether to further adjust the cache size of the cache memory system may include: determining that the hit rate associated with the cache memory has decreased in response to removing a portion of storage capacity from the cache memory system; and adjusting the cache size by adding the portion of storage capacity previously removed from the cache memory system. Determining whether to further adjust the cache size of the cache memory system may include: determining that the hit rate associated with the cache memory has not changed in response to adding a portion of storage capacity to the cache memory system; and adjusting the cache size by removing the portion of storage capacity previously added to the cache memory system.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a cache management process coupled to a distributed computing network according to one or more example implementations of the disclosure;

FIGS. 2-3 are example diagrammatic views of the storage system of FIG. 1 according to one or more example implementations of the disclosure;

FIG. 4 is an example flowchart of the cache management process of FIG. 1 according to one or more example implementations of the disclosure; and

FIG. 5 is an example diagrammatic view of the storage system of FIG. 1 according to one or more example implementations of the disclosure.

Like reference symbols in the various drawings indicate like elements.

### DETAILED DESCRIPTION

### System Overview:

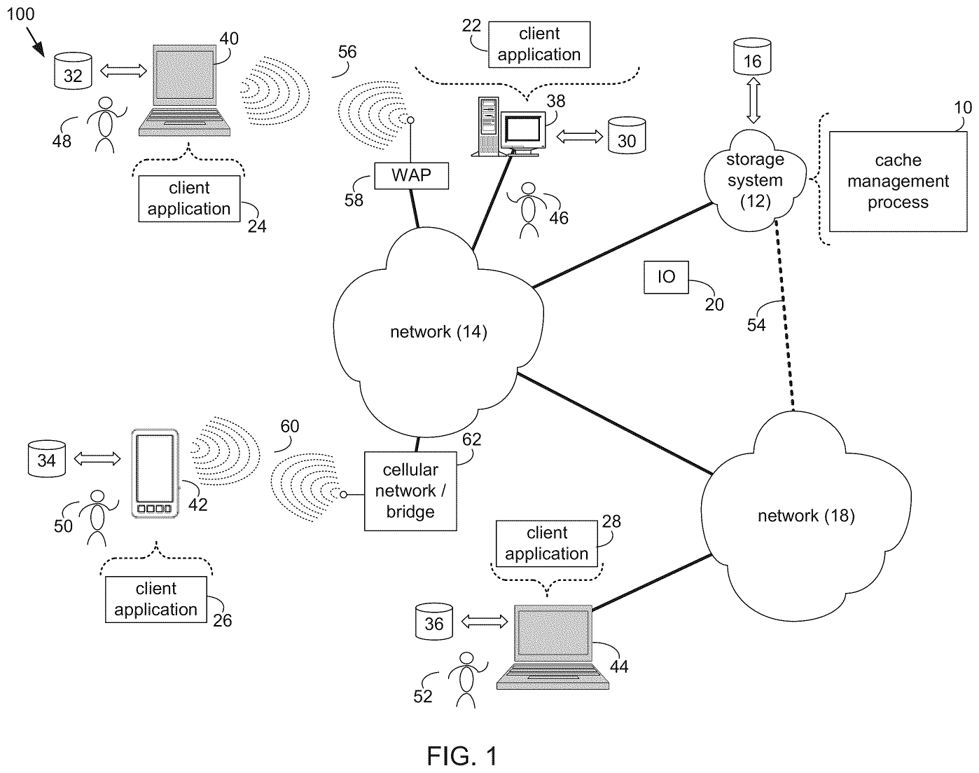

Referring to FIG. 1, there is shown cache management process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of cache management process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of cache management process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a cache management process, such as cache management process 10 of FIG. 1, may include but is not limited to, identifying a cache probe event associated with a cache memory system. A cache size of the cache memory system may be adjusted based upon, at least in part, the cache probe event. A cache size adjustment impact may be determined based upon, at least in part, a change in a hit rate associated with the cache memory system. It may be determined whether to further adjust the cache size of the cache memory system based upon, at least in part, the cache size adjustment impact.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System:

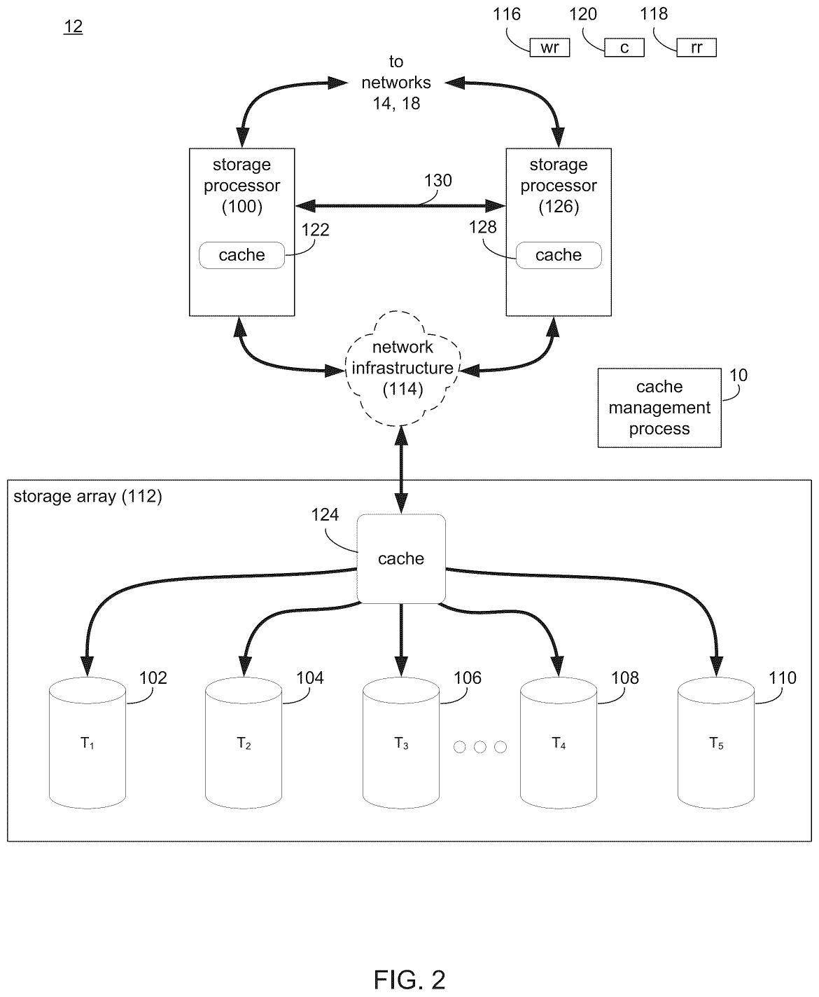

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g. storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g. the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g. the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of cache management process 10. The instruction sets and subroutines of cache management process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random access memory (RAM); a read-only memory (ROM); and all forms of flash memory storage devices. As discussed above, some portions of the instruction sets and subroutines of cache management process 10 may be stored on storage devices (and/or executed by processors and memory architectures) that are external to storage system 12.

As discussed above, various IO requests (e.g. IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e. a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g. one or more of storage targets 102, 104, 106, 108, and coded target 110.

As discussed above, the instruction sets and subroutines of cache management process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of cache management process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g. one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

In some implementations, storage system 12 may include multi-node active/active storage clusters configured to provide high availability to a user. As is known in the art, the term “high availability” may generally refer to systems or components that are durable and likely to operate continuously without failure for a long time. For example, an active/active storage cluster may be made up of at least two nodes (e.g., storage processors 100, 126), both actively running the same kind of service(s) simultaneously. One purpose of an active-active cluster may be to achieve load balancing. Load balancing may distribute workloads across all nodes in order to prevent any single node from getting overloaded. Because there are more nodes available to serve, there will also be a marked improvement in throughput and response times. Another purpose of an active-active cluster may be to provide at least one active node in the event that one of the nodes in the active-active cluster fails.

In some implementations, storage processor 126 may function like storage processor 100. For example, during operation of storage processor 126, content 118 to be written to storage system 12 may be processed by storage processor 126. Additionally/alternatively and when storage processor 126 is configured as an application server, content 118 to be written to storage system 12 may be internally generated by storage processor 126.

Storage processor 126 may include frontend cache memory system 128. Examples of frontend cache memory system 128 may include but are not limited to a volatile, solid-state, cache memory system (e.g., a dynamic RAM cache memory system) and/or a non-volatile, solid-state, cache memory system (e.g., a flash-based, cache memory system).

Storage processor 126 may initially store content 118 within frontend cache memory system 126. Depending upon the manner in which frontend cache memory system 128 is configured, storage processor 126 may immediately write content 118 to data array 112 (if frontend cache memory system 128 is configured as a write-through cache) or may subsequently write content 118 to data array 112 (if frontend cache memory system 128 is configured as a write-back cache).

In some implementations, the instruction sets and subroutines of cache management process 10, which may be stored on storage device 16 included within storage system 12, may be executed by one or more processors (not shown) and one or more memory architectures (not shown) included within storage system 12. Accordingly, in addition to being executed on storage processor 126, some or all of the instruction sets and subroutines of cache management process 10 may be executed by one or more processors (not shown) and one or more memory architectures (not shown) included within data array 112.

Further and as discussed above, during the operation of data array 112, content (e.g., content 118) to be written to data array 112 may be received from storage processor 126 and initially stored within backend cache memory system 124 prior to being stored on e.g. one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

As discussed above, storage processor 100 and storage processor 126 may be configured in an active/active configuration where processing of data by one storage processor may be synchronized to the other storage processor. For example, data may be synchronized between each storage processor via a separate link or connection (e.g., connection 130).

### Metadata Architecture:

In the context of storage systems, metadata may generally include useful internal information managed by a storage array to describe and locate user data. All modern arrays abstract the physical media and present logical (virtualized) addresses to clients in the form of LUNs. The mapping between the logical address and physical address is a form of metadata that the array needs to manage. That is typically the most common form of metadata for SAN storage systems. Newer architectures manage additional metadata to implement additional capabilities. For example, snapshots, change tracking for efficient remote replication, deduplication pointers, and compression all involve managing some form of metadata.

The classic metadata structure of traditional storage systems directly links a Logical Address of a Block to the Physical Location of the Block. In this metadata structure, every logical block written, has a physical block linked directly to it. In addition, as most traditional storage systems were architected for a spinning disk storage medium optimized for sequential writes the address of the logical address affects the physical location that the data is stored. This can lead to an unbalanced storage array that can suffer from hot-spots as specific address space ranges may experience more performance/input-output operations per second (IOPs) than other address space ranges.

Embodiments of the present disclosure may support a flash/random access medium. For example, embodiments of the present disclosure may include a metadata structure that completely decouples the Logical Block Address space address from the physical one. This is done by leveraging a multi-layer architecture.

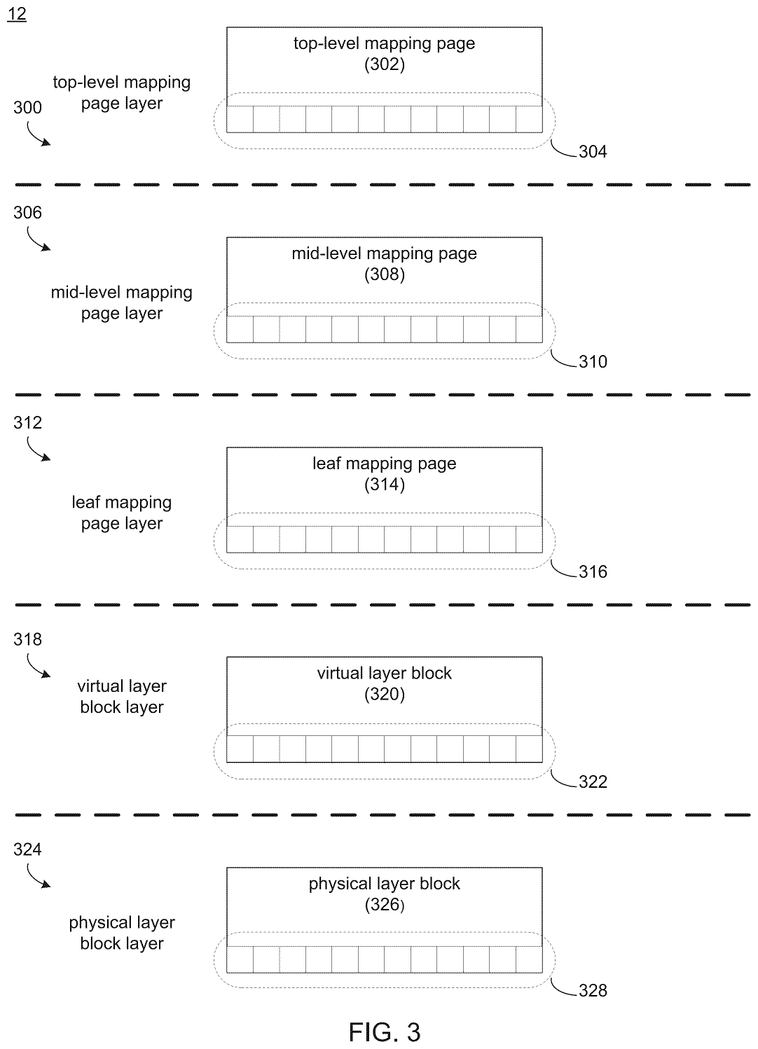

Referring also to FIG. 3, a storage system may generally include a mapper layer which is structured as a file system with various layers of pages and blocks. In some implementations, the combination of various metadata layers mapper layers may be referred to as a mapper metadata tree. While the following example includes metadata “blocks”, it will be appreciated that other units of data storage may be used within the scope of the present disclosure. In some implementations, a top-level mapping page layer (e.g., top-level mapping page layer 300) may include top-level mapping page pages (e.g., top-level mapping page 302) with a plurality of entries (e.g., plurality of entries 304) that map or point to a plurality of entries of one or more mid-level mapping pages. A mid-level mapping page layer (e.g., mid-level mapping page layer 306) may include mid-level mapping page pages (e.g., mid-level mapping page 308) with a plurality of entries (e.g., plurality of entries 310) that map or point to a plurality of entries of one or more leaf mapping pages. A leaf mapping page layer (e.g., leaf mapping page layer 312) may include leaf mapping page pages (e.g., leaf mapping page 314) with a plurality of entries (e.g., plurality of entries 316) that map or point to a plurality of entries of one or more virtual layer blocks. Leaf mapping page layer 312 may represent various ranges of Logical Block Addresses (LBAs). For example, each entry of the plurality of entries (e.g., plurality of entries 316) of the leaf mapping page (e.g., leaf mapping page 314) may be associated with a LBA range. In some implementations, the combination of top-level mapping page layer 300, mid-level mapping page layer 306, and leaf mapping page layer 312 may be organized in a “tree” data structure where each leaf mapping page is a “leaf” of the “tree” data structure that corresponds to a specific LBA range. Accordingly, each leaf mapping page (e.g., leaf mapping page 314) may hold mapping of a LBA to a virtual layer block. It will be appreciated that other data structures may be used within the scope of the present disclosure to organize the first layer.

In some implementations, a virtual layer block layer (e.g., second layer 318) may include virtual layer blocks (e.g., virtual layer block 320) with a plurality of entries (e.g., plurality of entries 322) that map to a plurality of entries of one or more physical data blocks. The virtual layer block layer (e.g., virtual layer block layer 318) may generally isolate the logical address of a block from the physical location of the block. For example, a virtual layer block (e.g., virtual layer block 308) may encapsulate the physical location of user data and allow relocation without updating leaf mapping pages (e.g., leaf mapping page 314). Accordingly, the virtual layer block layer (e.g., virtual layer block layer 318) may decouple the Logical Block Address space address from the physical one.

In some implementations, a physical data block layer (e.g., physical data block layer 324) may include physical data blocks (e.g., physical data block 326) with a plurality of entries or portions (e.g., plurality of entries 328) that are configured to store user data. In this manner, physical data block layer 324 may describe the physical location of user data in a storage system. In some implementations, each physical data block (e.g., physical data block 326) may have a predefined amount of storage capacity for storing data (e.g., user data).

### The Cache Management Process:

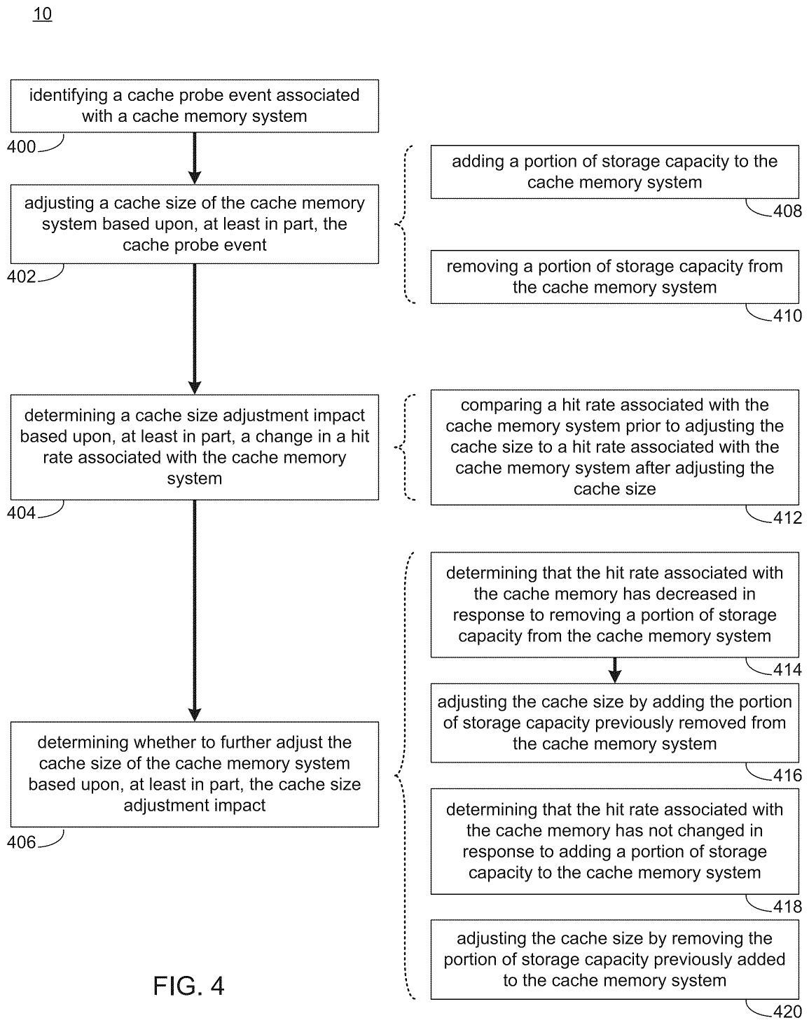

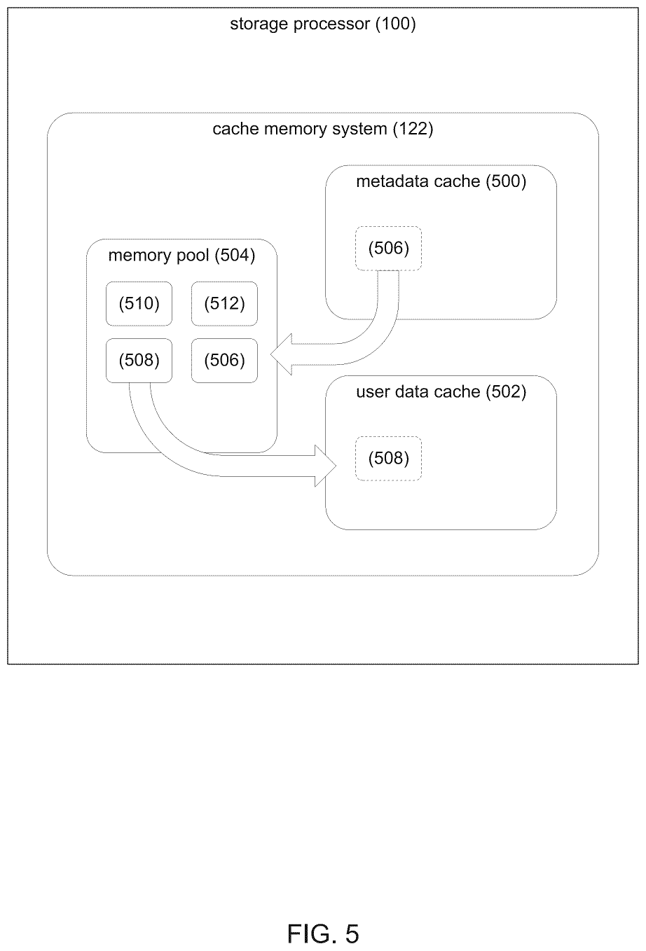

Referring also to FIGS. 4-5 and in some implementations, cache management process 10 may identify 400 a cache probe event associated with a cache memory system. A cache size of the cache memory system may be adjusted 402 based upon, at least in part, the cache probe event. A cache size adjustment impact may be determined 404 based upon, at least in part, a change in a hit rate associated with the cache memory system. It may be determined 406 whether to further adjust the cache size of the cache memory system based upon, at least in part, the cache size adjustment impact.

In some implementations, cache management process 10 may allow for adaptive cache sizing (i.e., either decrease or increase) during run-time, based on multiple triggers as will be described below, in order to optimize cache memory utilization and to improve the hit rate and overall storage system performance. For example, consider a storage system that implements a cache for fast data access. The system may use multiple cache instances, each of them may store one or more types of pages. Normally, a “hit ratio” metric is used to analyze how the cache is performing, by calculating the number of cache hits (i.e., the requested page was found in cache) divided by the total number of requests. However, this metric is very general, and may fail to detect cache inefficiencies. For example, consider a scenario where all the requests to the cache are for only e.g., five pages, out of 20,000 pages stored in the cache. In this case, the hit ratio will be equal to “1”, hiding the memory inefficiency, because significant memory portion may be freed up from the cache to be used by other cache instances or different system components, while getting the same cache performance and hit ratio of “1”.

Thus, such simple metrics do not represent whether the cache size is optimal or, for example, whether the cache size may be decreased by half, without visible performance impact; or the opposite—whether increasing the cache size by just e.g., five percent may improve the hit rate, and the performance dramatically. As will be discussed in greater detail below, implementations of the present disclosure may provide dynamically updated cache sizing to adapt to changes in IO patterns and to optimize the cache resource utilization. In this manner, overall system performance is increased.

In some implementations, cache management process 10 may identify 400 a cache probe event associated with a cache memory system. Referring also to FIG. 5 and as discussed above, a storage processor (e.g., storage processor 100) may include a cache memory system (e.g., cache memory system 122) configured to temporarily store data associated with one or more IO requests. For example, cache management process 10 may use cache memory system 122 to provide fast access to particular data that accessed more frequently than other data. In some implementations, the cache memory system may include one or more of a metadata cache and a user data cache. A metadata cache (e.g., metadata cache 500) may generally include a portion of cache memory system 122 that stores different types of metadata pages (e.g., virtual layer blocks, leaf mapping pages, mid-level mapping pages, and/or top-level mapping pages) as described above and shown in FIG. 3. A user data cache (e.g., user data cache 502) may generally include a portion of cache memory system 122 that stores user data pages (i.e., the content from IO write requests provided for storage in the storage system).

A cache probe event may be a predefined event or condition indicative of a change in the utilization of the cache memory system. In some implementations, the cache probe event includes one or more of a change in IO pattern, a change in cache memory system metrics, and a periodic cycle. In one example, cache management process 10 may identify a change in IO pattern. Referring again to FIG. 5 and in some implementations, suppose that storage processor 100 processes a plurality of IO requests on storage system 12. In this example, suppose that the pattern of IO requests include a particular number of IO requests, type of IO request (e.g., read IO versus write IO), throughput (e.g., input/output operations per second (IOPS), etc.). In response to determining a change in this IO pattern within a predefined interval of time, cache management process 10 may identify 400 a cache probe event.

In some implementations, a cache memory system metric may include a metric representative of the functionality and efficiency of the cache memory system. For example, examples of cache memory system metrics may include, but are not limited to, hit per page retention time (i.e., number of page hits in cache during page retention time), hit interval (i.e., the time between hits), retention time (i.e., amount of time a page or type of page is in the cache memory system), number of pages in the cache memory system, total IO request count, hit count, number of pages removed from the cache memory system, etc. Accordingly, cache management process 10 may maintain each cache memory system metric to determine any changes in the cache memory system metrics over time. For example, cache management process 10 may compare new or modified cache memory system metrics with the previous cache memory system metrics and a cache probe event threshold to determine whether the change in cache memory system 122 constitutes a cache probe event.

In some implementations, cache management process 10 may identify 400 a cache probe event by periodically sampling or determining changes in the IO pattern and/or cache memory system metrics. For example, cache management process 10 may maintain a temporal counter that will trigger a cache probe event if no cache probe event is identified during a particular time interval. In some implementations, the time interval for the periodic determination may be user-defined, a default value, and/or dynamically determined by cache management process 10. Accordingly, with a periodic determination, cache management process 10 may handle any change that was not detected by the IO pattern or the cache memory system metrics that may influence the optimized distribution of cache resources.

In some implementations, cache management process 10 may adjust 402 a cache size of the cache memory system based upon, at least in part, the cache probe event. For example, in response to identifying 400 a cache probe event, cache management process 10 may adjust or modify the cache size for the cache memory system. As discussed above, cache memory system 122 may include various caches (e.g., metadata cache 500 and user data cache 502). Accordingly, cache management process 10 may adjust 402 the cache associated with the cache probe event. In some implementations and in response to identifying 400 a cache probe event, cache management process 10 may process a “hits per retention time” histogram for each of the caches in the cache memory system. For example, cache management process 10 may maintain a histogram (or other data structure) to track distribution of pages within the cache memory system according to their number of hits. In some implementations, cache management process 10 may identify a cache in the cache memory system with a “percentage of pages with zero hits” is above a predefined threshold. If there are multiple caches that fulfill this condition, cache management process 10 may select the cache with the largest value (i.e., the largest “percentage of pages with zero hits” value) relative to the threshold. Cache management process 10 may store the cache hit rate as a “hit cache before change” value.

In some implementations, adjusting 402 the cache size of the cache memory system may include one or more of: adding 408 a portion of storage capacity to the cache memory system, and removing 410 a portion of storage capacity from the cache memory system. For example, the cache memory system may include portions of storage capacity allocated from a memory pool (e.g., memory pool 504) for caching data. In some implementations, the cache memory pool (e.g., memory pool 504) may be divided into predefined portions or chunks. Accordingly, the simplest way to adjust 402 the cache size is in chunk granularity. In some implementations, cache management process 10 may identify a cache from the cache memory system to adjust. As discussed above, cache management process 10 may maintain a listing of cache histogram or other data structure defining various cache memory system metrics including “percentage of pages with zero hits”. In some implementations, cache management process 10 may select the cache with the largest value (i.e., the largest “percentage of pages with zero hits” value) relative to the threshold and remove 410 a portion of storage capacity. For example, suppose cache management process 10 identifies a cache probe event associated with metadata cache 500. In this example, cache management process 10 may adjust 402 the cache size for metadata cache 500 by removing a portion of storage capacity (e.g., chunk 506). Cache management process 10 may identify the least recently used (LRU) chunk, and force evict from cache each of the occupied pages inside this chunk. Accordingly, cache management process 10 may remove 410 chunk 506 from metadata cache 500 (as shown in FIG. 5 with the arrow between metadata cache 500 and memory pool 504).

In some implementations, cache management process 10 may add 408 a portion of storage capacity to the cache memory system. For example, suppose cache management process 10 identifies a cache probe event that is indicative of low performance by user data cache 502. In this example, cache management process 10 may adjust 402 user data cache 502 by adding 408 a portion of storage capacity (e.g., a chunk) from memory pool 504. Accordingly, cache management process 10 may add 408 chunk 508 to user data cache 502 (as shown in FIG. 5 with the arrow between user data cache 502 and memory pool 504).

In some implementations, cache management process 10 may determine 404 a cache size adjustment impact based upon, at least in part, a change in a hit rate associated with the cache memory system. For example and as discussed above, cache management process 10 may dynamically adjust the cache size based upon, at least in part, the impact of the change in cache size on the performance of the cache memory system. In some implementations, the cache size adjustment impact may be a numerical representation of the change in cache memory system performance after adjusting 402 the cache memory system in response to the cache probe event. In some implementations, cache management process 10 may determine 404 the cache size adjustment impact after a predefined period of time (e.g., at least the old cache retention time plus the new cache retention time) in order to guarantee steady state after the cache changes. In some implementations, the predefined period of time before determining 404 the cache size adjustment impact may be user-defined, a default value, and/or dynamically adjusted by cache management process 10 based on cache memory system performance (i.e., to account for changes in cache retention time).

In some implementations, determining 404 the cache size adjustment impact may include comparing 412 a hit rate associated with the cache memory system prior to adjusting the cache size to a hit rate associated with the cache memory system after adjusting the cache size. For example, cache management process 10 may use a cache hit rate before and after the change to determine the cache size adjustment impact for the change in cache size. In some implementations, cache management process 10 may wait until the predefined period of time has concluded before comparing 412 the hit rate associated with the cache memory system prior to adjusting the cache size with the hit rate associated with the cache memory system after adjusting the cache size.

In some implementations, cache management process 10 may determine 406 whether to further adjust the cache size of the cache memory system based upon, at least in part, the cache size adjustment impact. For example, cache management process 10 may adjust the cache memory system by adding or removing portions of storage capacity. However, these changes may have a negative impact, no impact, or a positive impact. When an adjustment is made to the cache memory system, various external factors may also influence the impact of the changes. For example, a change in IO pattern may necessitate more cache memory system storage capacity just after a chunk was removed and a sudden drop in cache memory system page retention may free up capacity despite the addition of a new chunk. Accordingly, cache management process 10 may use the cache size adjustment impact to determine 406 whether to further adjust the cache size.

In some implementations, determining 406 whether to further adjust the cache size of the cache memory system may include: determining 414 that the hit rate associated with the cache memory has decreased in response to removing a portion of storage capacity from the cache memory system; and adjusting 416 the cache size by adding the portion of storage capacity previously removed from the cache memory system. For example, if the cache management process 10 determines 414 that the cache size adjustment impact (i.e., hit rate) has decreased (e.g., less than a predefined threshold) after removing 410 chunk 506 from metadata cache 500, cache management process 10 may adjust 416 the cache size by adding (e.g., returning) the removed chunk (e.g., chunk 506) back to the cache memory system (e.g., back to metadata cache 500). Similarly, if the cache management process 10 determines 414 that the cache size adjustment impact (i.e., the IO pattern has changed during this time duration), cache management process 10 may rollback the change by adding (e.g., returning) the removed chunk back to the cache memory system. However, if the hit rate is unchanged, cache management process 10 may permanently free the removed chunk, and add it to memory pool 504. The chunks in memory pool 504 (e.g., chunks 506, 508, 510, 512) may be used to increase the size of other caches in cache memory system 122 or for other purposes.

In some implementations, determining 406 whether to further adjust the cache size of the cache memory system may include: determining 418 that the hit rate associated with the cache memory has not changed in response to adding a portion of storage capacity to the cache memory system; and adjusting 420 the cache size by removing the portion of storage capacity previously added to the cache memory system. For example, suppose cache management process 10 adds chunk 508 to user data cache 502. If cache management process 10 determines 418 that, after the waiting time has passed, the updated hit rate is unchanged or the IO pattern has changed during the waiting time, cache management process 10 may adjust 420 the cache size by removing the added chunk (e.g., chunk 508). However, suppose that cache management process 10 determines that the hit rate has improved, cache management process 10 may keep the change without making further adjustments.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
identifying a cache probe event associated with a cache memory system;
adjusting a cache size of the cache memory system based upon, at least in part, the cache probe event;
determining a cache size adjustment impact based upon, at least in part, a change in a hit rate associated with the cache memory system; and
determining whether to further adjust the cache size of the cache memory system based upon, at least in part, the cache size adjustment impact.

2. The computer-implemented method of claim 1, wherein the cache memory system includes one or more of: a metadata cache and a user data cache.

3. The computer-implemented method of claim 1, wherein the cache probe event includes one or more of: a change in IO pattern, a change in cache memory system metrics, and a periodic cycle.

4. The computer-implemented method of claim 1, wherein adjusting the cache size of the cache memory system includes one or more of:
adding a portion of storage capacity to the cache memory system, and
removing a portion of storage capacity from the cache memory system.

5. The computer implemented method of claim 4, wherein determining the cache size adjustment impact includes comparing a hit rate associated with the cache memory system prior to adjusting the cache size to a hit rate associated with the cache memory system after adjusting the cache size.

6. The computer implemented method of claim 4, wherein determining whether to further adjust the cache size of the cache memory system includes:
determining that the hit rate associated with the cache memory has decreased in response to removing a portion of storage capacity from the cache memory system; and
adjusting the cache size by adding the portion of storage capacity previously removed from the cache memory system.

7. The computer implemented method of claim 4, wherein determining whether to further adjust the cache size of the cache memory system includes:
determining that the hit rate associated with the cache memory has not changed in response to adding a portion of storage capacity to the cache memory system; and
adjusting the cache size by removing the portion of storage capacity previously added to the cache memory system.

8. A computer program product residing on a non-transitory computer readable medium having a plurality of instructions stored thereon which, when executed by a processor, cause the processor to perform operations comprising:
identifying a cache probe event associated with a cache memory system;
adjusting a cache size of the cache memory system based upon, at least in part, the cache probe event;
determining a cache size adjustment impact based upon, at least in part, a change in a hit rate associated with the cache memory system; and
determining whether to further adjust the cache size of the cache memory system based upon, at least in part, the cache size adjustment impact.

9. The computer program product of claim 8, wherein the cache memory system includes one or more of: a metadata cache and a user data cache.

10. The computer program product of claim 8, wherein the cache probe event includes one or more of: a change in IO pattern, a change in cache memory system metrics, and a periodic cycle.

11. The computer program product of claim 8, wherein adjusting the cache size of the cache memory system includes one or more of:
adding a portion of storage capacity to the cache memory system, and
removing a portion of storage capacity from the cache memory system.

12. The computer program product of claim 11, wherein determining the cache size adjustment impact includes comparing a hit rate associated with the cache memory system prior to adjusting the cache size to a hit rate associated with the cache memory system after adjusting the cache size.

13. The computer program product of claim 11, wherein determining whether to further adjust the cache size of the cache memory system includes:
determining that the hit rate associated with the cache memory has decreased in response to removing a portion of storage capacity from the cache memory system; and
adjusting the cache size by adding the portion of storage capacity previously removed from the cache memory system.

14. The computer program product of claim 11, wherein determining whether to further adjust the cache size of the cache memory system includes:
determining that the hit rate associated with the cache memory has not changed in response to adding a portion of storage capacity to the cache memory system; and
adjusting the cache size by removing the portion of storage capacity previously added to the cache memory system.

15. A computing system comprising:
a memory; and
a processor configured to identify a cache probe event associated with a cache memory system, wherein the processor is further configured to adjust a cache size of the cache memory system based upon, at least in part, the cache probe event, wherein the processor is further configured to determine a cache size adjustment impact based upon, at least in part, a change in a hit rate associated with the cache memory system, and wherein the processor is further configured to determine whether to further adjust the cache size of the cache memory system based upon, at least in part, the cache size adjustment impact.

16. The computing system of claim 15, wherein the cache memory system includes one or more of: a metadata cache and a user data cache.

17. The computing system of claim 15, wherein the cache probe event includes one or more of: a change in IO pattern, a change in cache memory system metrics, and a periodic cycle.

18. The computing system of claim 15, wherein adjusting the cache size of the cache memory system includes one or more of:
adding a portion of storage capacity to the cache memory system, and
removing a portion of storage capacity from the cache memory system.

19. The computing system of claim 18, wherein determining the cache size adjustment impact includes comparing a hit rate associated with the cache memory system prior to adjusting the cache size to a hit rate associated with the cache memory system after adjusting the cache size.

20. The computing system of claim 18, wherein determining whether to further adjust the cache size of the cache memory system includes:
determining that the hit rate associated with the cache memory has decreased in response to removing a portion of storage capacity from the cache memory system; and
adjusting the cache size by adding the portion of storage capacity previously removed from the cache memory system.
